(19) United States
(12) Patent Application Publication
(10) Pub. No.: US 2004/0162779 A1
(43) Pub. Date: Aug. 19, 2004

(54) Digital image transfer station or kiosk

(76) Inventor: John Clay Kramer, Kokomo, IN (US)

Correspondence Address: John C. Kramer, 309 N Webster, Kokomo, IN, 46901, US

(21) Appl. No.: 10/368,062

(22) Filed: Feb. 19, 2003

(51) Int. Cl. G06F 17/60

(52) U.S. Cl. 705/40

(57) ABSTRACT

A publicly accessible stationary device for transferring still or moving images from removable storage medium devices used in digital still cameras and digital video recorders to an alternate low cost, portable, and permanent storage medium. Travelers would therefore be able to re-use their removable storage medium devices for additional digital image acquisition while preserving the images originally occupying their removable storage medium devices. The device includes a microcontroller, a temporary storage medium, a removable storage media reader, a alternate storage media recorder, and display and input devices for conducting a dialog with the user. A first embodiment describes an interactive self-service kiosk that prompts a user to insert their removable storage medium devices and alternate portable storage medium, then transfers the contents of the removable storage medium devices to the alternate portable storage medium while verifying that an accurate transfer did indeed occur. In a second embodiment, the kiosk includes payment acceptance and payment verification devices. In a third embodiment, the kiosk includes payment acceptance devices, payment verification devices, and an alternate storage medium dispenser. The station or kiosk may be accessed from a remote location for diagnostic, maintenance, sales, and repair purposes to minimize on-site support needs.

### BACKGROUND OF THE INVENTION

1. Field of the Invention

The present invention relates to still or moving images captured through the use of digital imaging devices such as digital still cameras or digital video recorders, and the transfer of said images from media used by those devices to an alternate storage media.

2. Description of the Related Art

The advent of digital still cameras and digital video recorders, sometimes called digital image capturing devices, has provided consumers with an alternative to film for image capture. Consumers can now capture images within the memory of these digital image capturing devices, and transfer the image data to their personal computer. Some of the operations that consumers can then perform on the image data include electronic distribution, enhancement, transfer to permanent storage, selective printing, and delivery to a photo processing lab for high quality printing. As long as a personal computer is available with adequate high capacity long term storage, such as a hard drive, there is virtually no limit on the number of images that can be captured and transferred.

One method of transferring image data from the digital image capturing device to a personal computer uses a cable to directly connect the digital image capturing device to a port on a personal computer.

A second method exists for a digital image capturing device that is equipped with a removable storage medium device, sometimes referred to as a memory card. The removable storage medium device can be removed from the digital image capturing device and inserted in a removable storage medium device reader, sometimes referred to as a card reader, that is attached to a personal computer. The image data stored on the removable storage medium device can then be transferred to a personal computer.

Additional methods of transferring digital image data to a personal computer are directly available to the consumer, but these additional methods also presuppose that the consumer has access to a personal computer.

While traveling, and especially while traveling to tourist type destinations such as theme parks, resorts, and cruise ships, consumers frequently do not have access to a personal computer. When the memory in their digital image capturing device becomes full, they are unable to transfer the digital images they have captured to long term storage. Therefore, they are unable to make space available on their digital image capturing device for more images. These tourist type destinations are also places that consumers tend to capture large numbers of images.

One solution would be for the consumer to purchase additional removable storage medium devices. This would allow the consumer to continue capturing images, but it would be quite an expensive solution due to the high cost of each removable storage medium device.

Another solution would be for the consumer to carry a portable personal computer, such as a notebook or laptop, while traveling. For a consumer that does not possess a portable personal computer it again would be quite an expensive solution. A consumer that already possesses a portable personal computer might find this solution acceptable, but that same consumer may also not consider it reasonable to be encumbered with a device larger and heavier than most digital image capturing devices solely for the purpose of transferring and storing images.

U.S. Pat. No. 6,337,712 issued on Jan. 8, 2002 to Shiota, et al., describes an additional solution whereby the image data is transferred to a remote image server for later access by the consumer. Many tourist or traveler destinations do not have the existent communication network that this solution would require. The installation cost of such a network can be prohibitively high. Additionally, many consumers consider their captured images to be personal and private. They may consider storage of their images along with those of other consumers unpalatable, or the need of an identification code for access as inconvenient.

### SUMMARY OF THE INVENTION

Accordingly, it is an object of this invention to provide a means whereby consumers without access to a personal computer can transfer digital image data captured on their digital image capturing device to an alternate form of portable storage. Thus making space available for capturing additional digital images.

It is a further object of this invention that the alternate form of portable storage used to record their digital image data be easily accessed by the traveling consumer when they again have access to a personal computer.

It is a further object of this invention that no digital image data leave the immediate vicinity of the consumer, and that any temporary copies of the digital image data owned by the consumer be destroyed at the conclusion of the transfer.

It is a further object of this invention that when a communication network is available, diagnostic, maintenance, sales, and repair information may be remotely collected or performed.

‘Removable storage medium device’ as herein used means a device sometimes referred to as a memory card, but is more frequently referred to by proprietary names such as “CompactFlash” from SanDisk Corp., “Memory Stick” from Sony, “SmartMedia” from TOSHIBA, or the like. The intended use of said device is its insertion into a digital still camera or digital video recorder, and the subsequent storage of captured images on the device.

‘Alternate storage medium’, ‘alternate portable storage medium’, ‘alternate form of portable storage’, and other variants as herein used means a storage medium that meets the criteria of low cost, high density, portability, permanence, and compatibility with personal computers. Currently, a medium such as recordable compact disk, also known as CD-R, meets the aforementioned criteria.

Permanence does not imply that the alternate storage medium may not be re-used, it only means that the data contained therein is not easily lost.

### BRIEF DESCRIPTION OF THE DRAWINGS

FIG. 1 is a frontal view of the preferred embodiment of the invention.

FIG. 2 is a block diagram of the preferred embodiment of the invention illustrating components not visible in FIG. 1

### REFERENCE NUMERALS IN DRAWINGS

10—Self Contained Cabinet

12—Removable Storage Medium Reader

14—Display Device

16—Alternate Storage Medium Recorder

18—Push Buttons

20—Kiosk

22—Removable Storage Medium Reader

24—Power Supply

26—Microcontroller

28—Temporary Storage Media

30—Display Device and Push Buttons

32—Alternate Storage Medium Recorder

### DETAILED DESCRIPTION OF THE INVENTION

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

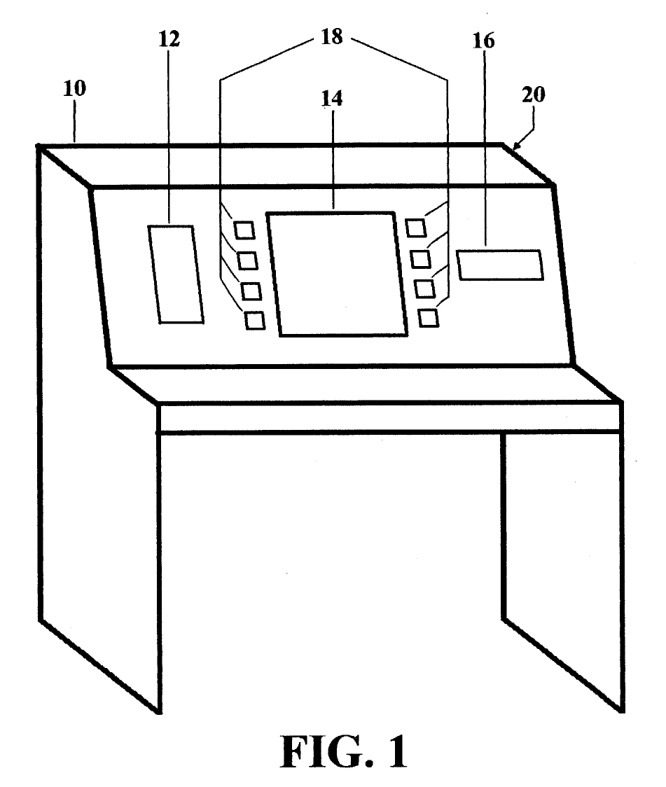

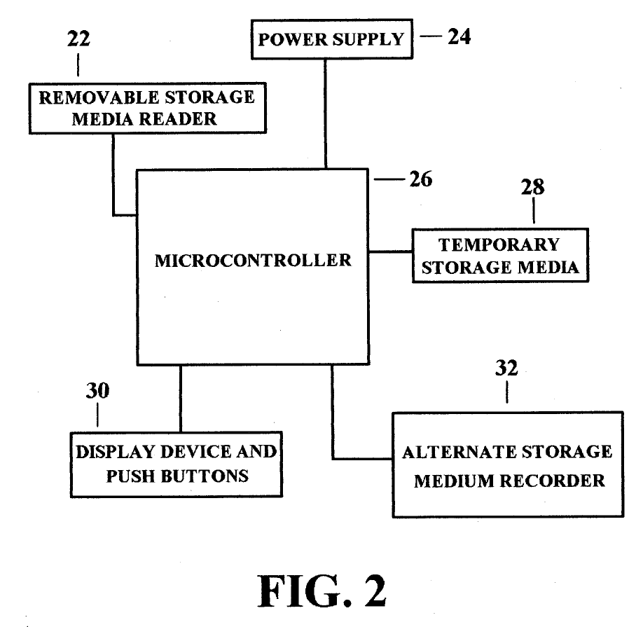

The present invention (refer to FIG. 1) provides a digital image transfer station or kiosk 20 whereby digital image data captured using a digital still camera (not shown) or digital video recorder (not shown) is transferred from the removable storage medium device (not shown) of said capture devices to an alternate portable storage medium (not shown). FIG. 2 contains a block diagram that includes components not visible in FIG. 1.

In the preferred embodiment (FIG. 1), digital image transfer station or kiosk 20 has a limited access self-contained cabinet 10. Cabinet can be constructed from wood, plastic, metal or other suitable material. Contained within cabinet 10, and partially accessible to the user, are removable storage medium reader 12, alternate storage medium recorder 16, display device 14, and push buttons 18 for user input. Push buttons 18 may not be necessary if display device 14 is of the touch screen type. Removable storage medium reader 12 is configured to accept all types of removable storage medium devices (not shown) commonly used with digital still cameras (not shown) or digital video recorders (not shown). The common types include those with proprietary names such as “ComapctFlash” from SanDisk, “Memory Stick” from Sony, “Smart Media” from TOSHIBA, or the like. Alternate portable storage medium recorder, 16, is configured to accept recordable compact disk media (not shown). It is recognized that any portable storage medium that meets the criteria of low cost, high density, portability, permanence, and compatibility with personal computers could be utilized instead of recordable compact disk. Microcontroller 26, power supply 24, and temporary storage media 28, as shown in FIG. 2, are inaccessible to the user. Microcontroller 26 is connected to all electronic components in the system and provides coordination and control of their activity, including prompting the user through display device 14, and interpreting user input through push buttons 18. Temporary storage medium 28 contains a copy of the users digital image data while the digital image data is transferred to alternate portable storage medium (not shown). This copy of the users digital image data is destroyed upon completion of a successful transfer, or upon cancellation of the transfer.

Digital image transfer station or kiosk 20 may have optional payment collection and verification devices (not shown). These may include coin, token, currency and if a suitable communication medium is available, credit and debit cards. Additionally, an optional mechanism (not shown) for dispensing the media used in alternate storage medium recorder 16 may also be present.

Operation begins once the user selects a language appropriate to the user for receiving prompts from digital image transfer station or kiosk 20. The user is then prompted to insert the alternate portable storage medium (not shown) into alternate storage medium recorder 16. Microcontroller 26 confirms that a suitable alternate portable storage medium (not shown) was inserted, then prompts the user to insert a removable storage medium device (not shown) into removable storage medium device reader 12.

Once microcontroller 26 confirms that a removable storage medium device (not shown) was inserted, it instructs the user to not remove the removable storage medium device until notified to do so. Microcontroller 26 then copies all data from the removable storage medium device to temporary storage medium 28 while verifying an accurate copy did occur, then prompts the user to remove the removable storage medium device (not shown). The user is then given the opportunity to insert additional removable storage medium devices (not shown) and repeat the above sequence, or complete the transfer. If Microcontroller 26 determines that the quantity of digital image data will exceed the capacity of the alternate portable storage medium (not shown), the user is given an appropriate set of options. These options include, but are not limited to, cancellation of the transfer, transferring a portion of the digital image data, or transferring all of the digital image data across multiple alternate portable storage media.

When the user has confirmed that no more removable storage medium devices (not shown) will be inserted, microcontroller 26 copies all data that resides on temporary storage media 28, originally from the removable storage medium devices (not shown), to the alternate portable storage medium (not shown) and confirms that an accurate copy did occur. The structure of the data copied to the alternate portable storage medium will be of a form that uniquely identifies each removable storage medium device that was used, will not rename any of the users image data files, and will include any additional non-image data files that originally resided on the removable storage medium devices. The user is then instructed to retrieve the alternate portable storage medium, and the transaction is concluded.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A publicly accessible stationary system to transfer still or moving image data from removable storage medium devices to an alternate portable storage medium, comprising:
(a) a kiosk housing;
(b) at least one removable storage medium device reader;
(c) at least one storage medium recorder that accepts said alternate portable storage media;
(d) a microcontroller with display and input devices that conducts a dialog with the user which:
(1) provides means to read said image data from said removable storage medium devices,
(2) provides means to record said image data onto said alternate portable storage media,
(3) provides means to verify that said image data was correctly recorded.

2. The system as recited in claim 1, which further comprises:
(a) payment acceptance and payment verification devices for use of said publicly accessible stationary system.

3. The system as recited in claim 2, which further comprises;
(a) a mechanism for dispensing said alternate portable storage media used in said storage medium recorder.
